(19) United States
(12) Patent Application Publication
(10) Pub. No.: US 2004/0148212 A1
(43) Pub. Date: Jul. 29, 2004

(54) Method and apparatus for measuring optimality for master production schedules

(75) Inventors: Kan Wu, Hsinchu (TW); Keung Hui, Hong Kong (HK); Thomas Chen, Hsin-Chu (TW); Robert Chien, Taichung City (TW)

Correspondence Address: GEORGE O. SAILE & ASSOCIATES, 28 DAVIS AVENUE, POUGHKEEPSIE, NY, 12603, US

(73) Assignee: Taiwan Semiconductor Manufacturing Company

(21) Appl. No.: 10/353,237

(22) Filed: Jan. 28, 2003

(51) Int. Cl. G06F 17/60

(52) U.S. Cl. 705/8

(57) ABSTRACT

A method for evaluation of optimality of a master production schedule begins by obtaining a forecasted operation schedule, the master production schedule, and an operation completion time. A master production schedule variance is determined from the master production schedule and the operation completion time. Then, a forecasted operation schedule variance is determined from the forecasted operation schedule and the operation completion time. An optimality index is an indicator of the optimality of the master production schedule, which is determined as a function of the operation schedule variance to the forecasted schedule variance. A penalty for deviation of the operation completion time deviation from the master production schedule may be incorporated into the determination. A third embodiment of the method evaluates the concentration/dispersion of the master production schedule variance and provides a better optimality index for a more concentrated distribution of the planned operation index.

### BACKGROUND OF THE INVENTION

1. Field of the Invention

This invention relates generally to methods and systems for generating master production schedules for planning usage of fabrication and processing equipment of a manufacturing line. More particularly, this invention relates to methods and apparatus for determining whether methods and systems that generate master production schedules are optimum

2. Description of Related Art

Computer software for the generation of operational planning of usage of fabrication or processing equipment of a fabrication line, as is known in the art, produce a master production schedule, such as from ADEXA, Inc. and i2 Technologies, Inc. These programs employ information from the sales prediction plan, order entry, and customer information residing in the marketing database; information from the production equipment inventory describing equipment status and availability, raw material supply, product process definition residing in a manufacturing information database, and production status; and a model of each of the fabrication lines of the manufacturing facility residing in the MPS database. The MPS programs then employ scheduling algorithms to develop a planned operation schedule for the manufacturing line that is most efficient and allows maximizing of the utilization of the manufacturing lines. Further, the scheduling attempts to insure that scheduled and promised product delivery dates are met.

While the algorithms of the MPS software attempt to optimize utilization of the fabrication lines of the manufacturing facility, there is no method or system available to establish an objective criterion for the optimality of the master production schedules as generated by MPS software.

U.S. Pat. No. 5,825,650 (Wang) describes a method for generating a model for predicting standard cycle time for a semiconductor process stage. A generic cycle time model is created based on Little's formula and Kingman's equation. Past cycle times as related to equipment utilization are used to generate a regression curve. The regression curve is then used to determine the coefficients of the generic cycle time model. Then, the standard cycle time of a stage for a future upcoming cycle is determined by using the cycle time model.

U.S. Pat. No. 6,119,102 (Rush, et al.) illustrates a manufacturing resource planning (MRP) system with viewable master production schedule. The MRP system begins by creating a master production schedule (MPS). The MPS is a data set indicating what quantity of product needs to be produced on what date to support the independent demand, i.e., sales orders, job orders and forecasts. Four data set files are used to create the MPS: customer orders (sales orders), scheduled receipts (job and purchase orders), sales forecasts and master scheduled activity. After MPS regeneration has occurred, the user may regenerate MRP.

U.S. Pat. No. 5,231,567 (Matoba, et al.) teaches a manufacturing planning system. The manufacturing planning system has lead time estimating function, MRP executing function, work demand calculating function, problem analyzing function, capacity adjusting function, product completion data adjusting function, and alternative shop designating function for planning a production schedule by calculating successively lead time in consideration of amount of work demanded and capacity for production, analyzing problems in the production schedule and performing relevant adjustments for solving the problems. An on-line display function is provided for simultaneous display of the problems and load/capacity states of production shops in association with solution of the problems and various adjustments.

U.S. Pat. No. 5,880,960 (Lin, et al.) describes a method for improving Work-in-Progress (WIP) balance in a manufacturing line. The method provides an index of line balance method for maintaining optimum queued quantities of products at a manufacturing step and over an entire manufacturing line.

### SUMMARY OF THE INVENTION

An object of this invention is to provide a method for evaluation of optimality of a planned operation schedule such as a master production schedule.

To accomplish at least this object, a method for determining optimality of a planned operation schedule begins by obtaining a forecasted operation schedule, the planned operation schedule, and an operation completion time. The forecasted operation schedule is a forecasted order date, which is a predicted date at which a customer is expected to require a product. The operation completion date is an order confirmed date indicating completion of fabrication of the product. A planned operation schedule variance is determined from the planned operation schedule and the operation completion time. Then, a forecasted operation schedule variance is determined from the forecasted operation schedule and the operation completion time. An optimality index is determined as a function of the operation schedule variance to the forecasted schedule variance. The magnitude of the optimality index is an indicator of the optimality of the planned operation schedule as generated.

The planned operation schedule variance is determined by the formula:

$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$

where:

D₁ is the planned operation schedule variance.

MPSDateᵢ is the planned operation schedule for operation i.

OCDᵢ is the operation completion date for the operation i.

n is a quantity of each operation i with n operation counts.

The forecasted operation schedule variance is determined by the formula:

$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$

where:

D₂ is the forecasted operation schedule variance.

FODᵢ is the forecasted operation schedule for operation i.

OCDᵢ is the operation completion date for the operation i.

n is a quantity of each operation i with n operation counts.

The function of the optimality index is determined by the formula:

$$MPSOI = \frac{{D}_{2}}{{D}_{1}}$$

where:

MPSOI is the optimality index.

D₁ is the planned operation schedule variance.

D₂ is the forecasted operation schedule variance.

In a second embodiment of the method, the planned operation schedule variance is determined by the formula:

$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$

where:

D₁ is the planned operation schedule variance.

MPSDateᵢ is the planned operation schedule for operation i.

OCDᵢ is the operation completion date for the operation i.

pᵢ is the penalty factor for operation i having missed the operation completion date.

n is a quantity of each operation i with n operation counts.

In the second embodiment of method, the forecasted operation schedule variance is determined by the formula:

$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$

where:

D₂ is the forecasted operation schedule variance.

FODᵢ is the forecasted operation schedule for operation i.

OCDᵢ is the operation completion date for the operation i.

pᵢ is the penalty factor for operation i having missed the operation completion date.

n is a quantity of each operation i with n operation counts.

In a third embodiment of the method, the optimality index is a concentration/dispersion factor of the operation schedule variance. The concentration/dispersion factor is determined by the formula:

Z=A₃²−(A₁\overline{X₁})·(A₂\overline{X₂})

where:

Z is the concentration/dispersion factor.

A₁ is a fraction of a distribution of the planned operation schedule variance greater than an operation completion time tolerance, the operation completion time tolerance being a tolerance of the operation completion times for multiple operations.

A₂ is a fraction of the distribution of planned operation schedule variance less than the operation completion time tolerance.

A₃ is a fraction of the distribution of planned operation schedule variance within the operation completion time tolerance.

\overline{X₁} is the mean of the distribution of the planned operation schedule variance greater than the operation completion time tolerance.

\overline{X₂} is the mean of the distribution of planned operation schedule variance less than the operation completion time tolerance.

The fraction of a distribution of planned operation schedule variance greater than an operation completion time variance is determined by the formula:

$${A}_{1} = {\int }_{- ∞}^{{0}^{-}} {y}_{lead} ( x ) ⅆ x$$

where:

A₁ is a fraction of the distribution of planned operation schedule variance greater than the operation completion time tolerance,

y_{lead} is a magnitude of planned operation schedule variance for the planned operations having an operation completion time less than the operation completion time tolerance, and

x is a planned operation schedule variance.

The fraction of a distribution of planned operation schedule variance less than an operation completion time variance is determined by the formula:

$${A}_{2} = {\int }_{{0}^{+}}^{+ ∞} {y}_{lag} ( x ) ⅆ x$$

where:

A₂ is a fraction of the distribution of planned operation schedule variance less than the operation completion time tolerance.

y_{lag} is a magnitude of planned operation schedule variance for the planned operations having an operation completion time greater than the operation completion time tolerance.

x is a planned operation schedule variance.

The fraction of a distribution of planned operation schedule variance greater than an operation completion time variance is determined by the formula:

$${A}_{3} = {\int }_{{0}^{-}}^{0 +} y ( x ) ⅆ x \\ = 1 - {A}_{1} - {A}_{2}$$

where:

A₃ is a fraction of the distribution of planned operation schedule variance within the operation completion time tolerance.

y is a magnitude of planned operation schedule variance for the planned operations having an operation completion time within the operation completion time tolerance.

x is a planned operation schedule variance.

The mean of the distribution of the planned operation schedule variance greater than the operation completion time tolerance is determined by the formula:

$$\overline{{X}_{1}} = \frac{{\int }_{- ∞}^{{0}^{-}} y ( x ) x ⅆ x}{{\int }_{- ∞}^{{0}^{-}} y ( x ) ⅆ x}$$

\overline{X₁} is the mean of the distribution of the planned operation schedule variance greater than the operation completion time tolerance.

y is a magnitude of planned operation schedule variance for the planned operations having an operation completion time within the operation completion time tolerance, and

x is a planned operation schedule variance.

The mean of the distribution of the planned operation schedule variance greater than the operation completion time tolerance is determined by the formula:

$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x}$$

\overline{X₂} is the mean of the distribution of planned operation schedule variance less than the operation completion time tolerance.

y is a magnitude of planned operation schedule variance for the planned operations having an operation completion time within the operation completion time tolerance, and

x is a planned operation schedule variance.

### BRIEF DESCRIPTION OF THE DRAWINGS

FIG. 1 is a functional diagram of a system for determining a master production schedule and the optimality of the master production schedule of this invention.

FIG. 2 is a process flow diagram of a method for determining a master production schedule and the optimality of the master production schedule of this invention.

FIG. 3 is process flow diagram of a first embodiment of the calculation of the optimality index as determined by the step of calculating the optimality index of FIG. 2 of this invention.

FIG. 4 is process flow diagram of a second embodiment of the calculation of the optimality index as determined by the step of calculating the optimality index of FIG. 2 of this invention.

FIGS. 5a-5f are plots of the variance of the order completion dates, the forecasted completion dates, and the master production schedules to illustrate the potential variance of the master production schedules.

FIG. 6 is a plot of the variance of the master production schedules defining the regions of variance of this invention.

FIG. 7 is process flow diagram of a third embodiment of the calculation of the optimality index as determined by the step of calculating the optimality index of FIG. 2 of this invention.

FIG. 8 is a chart illustrating the results of the third embodiment of the calculation of the optimality index of this invention.

### DETAILED DESCRIPTION OF THE INVENTION

To establish an objective criterion of the performance of software and systems that create planned operation schedules such as a MPS generator, the accuracy of the MPS generator must be compared to the operation completion date or order completion date. A factor in the generation of the MPS generator is the forecasted operation schedule or the forecasted product output date. An objective criterion for the MPS, as created by the MPS generator, is to compare the variance of the MPS to the order completion dates and the variance of the forecasted product output dates to the order completion dates. An index of the ratio of the MPS to the variance of the forecasted product output dates provides a measure of the ability of the MPS to match the actual operation of process lines within a manufacturing firm. A penalty to account for whether significant portions of the production either lead or lag the forecasted production dates, or the types and requirements of the customer purchasing the product, or other business concerns that may effect the variance of the forecasted and scheduled production from the actual product order completion date.

Additionally, the variance of the MPS from the actual product order completion date when examined over a number of orders is going to have a distribution. That distribution can then be examined for concentration and dispersion of the variance of the MPS versus the actual product order completion dates. The concentration and dispersion is calculated and becomes the index defining the quality of the performance of the MPS generator.

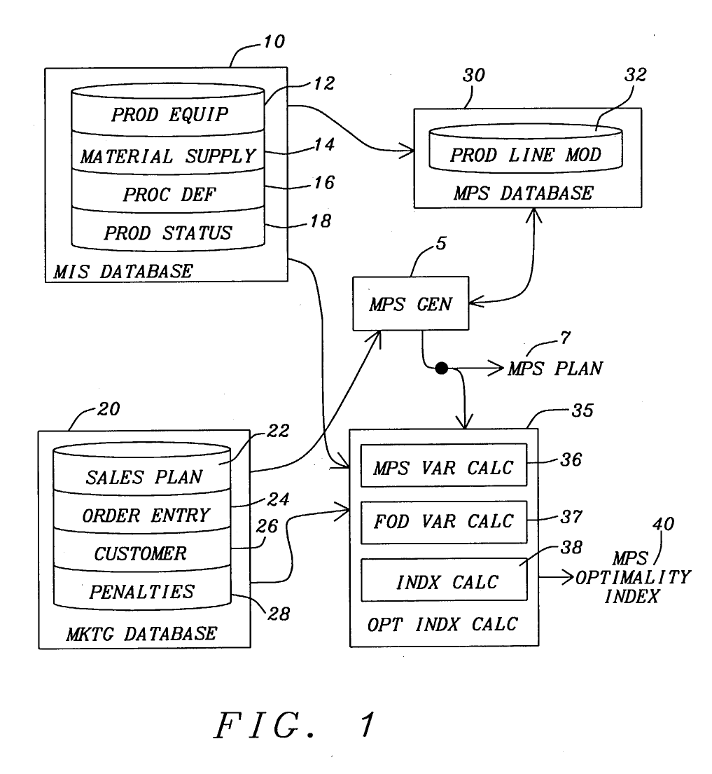

Refer now to FIG. 1 for a discussion of the structure of a system for generating a master production schedule and from the generation of the master production schedules and subsequent order completions, calculating an optimality index describing the quality of the MPS generation. The MPS generator 5 is connected to the Manufacturing Information System (MIS) database 10 to receive a current inventory of the available processing equipment 12. The inventory 12 details the types, number, and location of processing equipment that is available for use on a fabrication line of the manufacturing firm. The MIS database 10 provides an inventory of the raw material supply 14. The inventory 14 includes the raw material stock on hand as well as the necessary information for providing “just-in-time” delivery of raw material not stocked by the manufacturing firm. The MIS database 10 provides the process definition information 16 detailing the necessary production equipment and raw material necessary for the fabrication of the product. Additionally, the MIS database 10 provides the production status as the product is fabricated until the order is completed and transported.

The MPS generator 5 is connected to the marketing database 20 to receive the forecasted product output dates from the sales plan database 22. The order entry database 24 allows the forecasted product output dates to be updated with formal order information data describing customer requirements. The customer tier database 26 provides customer information regarding customer scheduling requirements and other information for determining if any penalties 28 are assessed for wide variances in the MPS scheduling versus the actual product order completion dates.

The MPS database 30 retains a product fabrication line model 32 detailing the structure of the fabrication line describing the product fabrication throughput rates including necessary statistics detailing arrival rates of work in progress for each of the steps of the fabrication for each type of process being performed on the fabrication lines of the manufacturing firm. The product fabrication line model 32 is connected to the MIS database 10 to receive any necessary information regarding the availability of the production equipment and the raw materials for the necessary input information for the product fabrication line model 32. The MPS generator 5 exercises the product fabrication line model 32 with the information of the MIS database 10 and the marketing database 20 to develop the MPS 7 as an output of the system.

The optimality index calculator 35 receives the MPS 7, the product order completion dates from the production status 18 of the MIS database 10, and the forecasted order completion date from the sales plan 22 of the marketing database 20. The optimality index calculator 35 has a MPS variance calculator 36, which calculates the MPS variance by solving the formula:

$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$

where:

D₁ is the MPS variance.

MPSDateᵢ is the MPS as generated by the MPS generator 5 for operation i.

OCDᵢ is the product order completion date for the operation i.

n is a quantity of each order i with n order counts.

The optimality index calculator 35 has a forecasted product output date variance calculator 37, which determines the forecasted product output data variance by solving the formula:

$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$

where:

D₂ is the forecasted product output date variance.

FODᵢ is the forecasted product output date for operation i.

OCDᵢ is the product order completion date for the operation i.

n is a quantity of each order i with n order counts.

The MPS variance is influenced by the capacity of the fabrication line from changes and allocation in the fabrication equipment. The MPS variance is further influenced by the confirmed order patterns for the quantities and types of products orders. Further, the effectiveness of the MPS generator's 5 optimization engine and the reasonability of the MPS generator 5 settings and rules for the production line model 32 influence the MPS variance. The forecasted product output date variance is influenced by the changes in the capacity of the fabrication line and the confirmed order patterns. The ratio of the MPS variance to the forecasted product output date variance provides an objective criterion for judging the effectiveness of the MPS generator 5.

The optimality index calculator 35 has an index calculator 38 connected to the MPS variance calculator 36 and the MPS variance calculator 36. The index calculator 28 determines the MPS optimality index by solving the formula:

$$MPSOI = \frac{{D}_{2}}{{D}_{1}}$$

where:

MPSOI is the optimality index.

D₁ is the planned operation schedule variance.

D₂ is the forecasted operation schedule variance.

In a second embodiment of the optimality calculator, a penalty factor 28 is introduced. The penalty factor 28 is a function of the impact of the lead versus the lag of the MPS versus the product order completion dates, the customer tier (the type of customer and penalties caused by variations in product order delivery dates versus the planned delivery date), and business concerns that are affected by the variations in the product order completion dates versus the planned production schedules.

In the second embodiment, the optimality index calculator 35 receives the MPS 7, the product order completion dates from the production status 18 of the MIS database 10, the forecasted order completion date from the sales plan 22 and the penalty factor 28 of the marketing database 20. The optimality index calculator 35 has a MPS variance calculator 36, which calculates the MPS variance by solving the formula:

$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$

where:

D₁ is the planned operation schedule variance.

MPSDateᵢ is the MPS as generated by the MPS generator 5 for operation i.

OCDᵢ is the product order completion date for the operation i.

pᵢ is the penalty factor for operation i having missed the operation completion date.

n is a quantity of each operation i with n operation counts.

In the second embodiment of method, the optimality index calculator 35 has a forecasted product output date variance calculator 37, which determines the forecasted product output data variance by solving the formula:

$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$

where:

D₂ is the forecasted operation schedule variance.

FODᵢ is the forecasted product output date for operation i.

OCDᵢ is the product order completion date for the operation i.

pᵢ is the penalty factor for operation i having missed the operation completion date.

n is a quantity of each operation i with n operation counts.

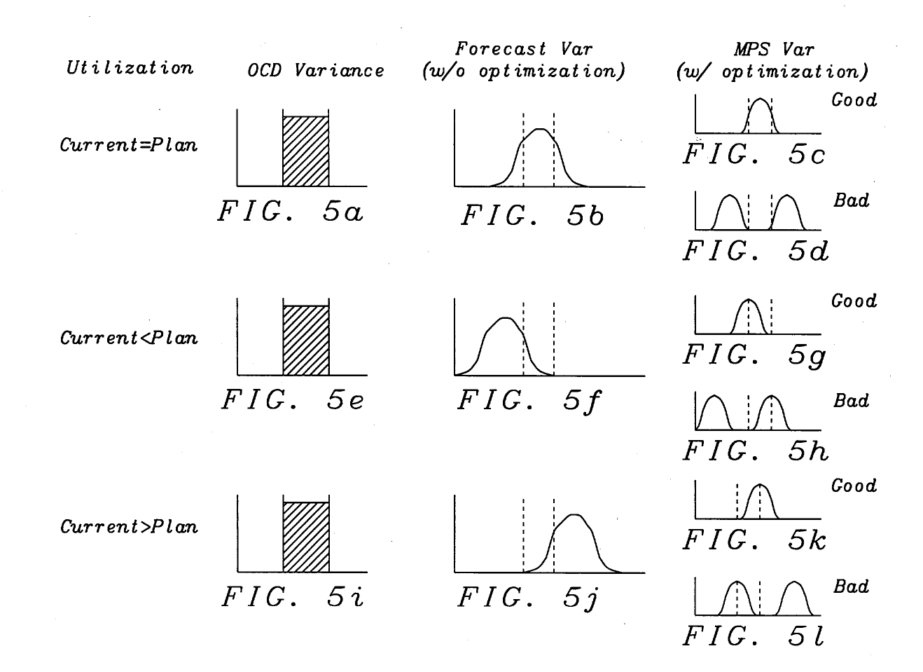

The penalties of differentiating between actual product order completion date and the forecasted product output date is difficult to predict and is assumed to be one. Further, the distribution of forecasted product output dates are also, difficult to predict. It can be shown that the MPS is more optimum is if the distribution of the MPS iterations over time are more concentrated. Refer now to FIGS. 5a-5l, for a discussion of variations of the MPS iterations to determine optimality of the MPS schedule generator 5. The variance of the product order completion dates is defined in FIGS. 5a, 5e, and 5i as the tolerance in the completion of processes during the fabrication of product. The variance in the forecasted product output date is shown in FIGS. 5b, 5f, and 5j. In FIG. 5b, the forecasted product output date variation over multiple iterations of the forecasts shows a case where the forecasted product output dates generally are equal the to product order output dates. In FIG. 5f, the actual product order output dates are generally later than the forecasted product output dates, and FIG. 5j shows the actual order output dates being earlier than the forecasted product output dates.

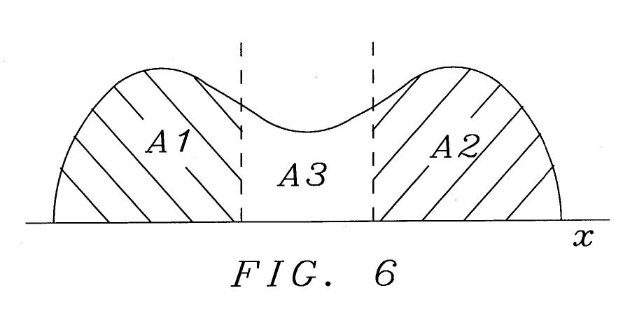

It has been observed that the variance of MPS iterations may be vary concentrated as shown in FIGS. 5c, 5g, and 5k or dispersed such that the distribution may in fact have to separate peaks as shown in FIGS. 5d, 5h, and 5l. Having the wide dispersion of FIGS. 5d, 5h, and 5l is not satisfactory for providing the scheduling of an optimum usage of the production line. A concentrated distribution is more satisfactory as shown in FIGS. 5c, 5g, and 5k, since the MPS provides a more predictable result. If the MPS is consistently early or late relative to the actual product order completion date, the rules for the MPS generator 5 may be modified to permit a more accurate scheduling of usage of the processing equipment on the fabrication lines of the manufacturing firm. To determine the concentration and dispersion of the distribution of the variance of multiple MPS iterations, an area for each region of the distribution is calculated. The distribution as shown in FIG. 6 is divided into three areas, A1, A2, and A3. The area A1 is for that portion of the distribution where the product order completion date is earlier than the MPS (lead) and the area A2 is for that portion of the distribution where the product order completion date is later than the MPS (lag). The area A3 is that portion of the distribution where the product order completion dates and the MPS match. The optimality index is structured to provide a penalty for more dispersed MPS variation distributions. The areas are determined and combined to form a concentration/dispersion factor used as the optimality index.

In a third embodiment of the optimality calculator 38, the optimality index is a concentration/dispersion factor of the operation schedule variance. The concentration/dispersion factor is determined by the optimality calculator 38 solving the formula:

$$\begin{matrix}Z = {A}_{3}^{2} - ( {A}_{1} \overline{{X}_{1}} ) \cdot ( {A}_{2} \overline{{X}_{2}} ) \\ = {( 1 - {A}_{1} - {A}_{2} )}^{2} - ( {A}_{1} \overline{{X}_{1}} ) \cdot ( {A}_{2} \overline{{X}_{2}} )\end{matrix}$$

where:

Z is the concentration/dispersion factor.

A₁ is a fraction of a distribution of the MPS variance greater than an product order completion time tolerance, the product order completion time tolerance being a tolerance of the product order completion times for multiple operations.

A₂ is a fraction of the distribution of MPS variance less than the product order completion time tolerance.

A₃ is a fraction of the distribution of MPS variance within the product order completion time tolerance.

\overline{X₁} is the mean of the distribution of the MPS variance greater than the product order completion time tolerance.

\overline{X₂} is the mean of the distribution of MPS variance less than the product order completion time tolerance.

The fraction of a distribution of MPS variance greater than an product order completion time variance is determined by the formula:

$${A}_{1} = {\int }_{- ∞}^{{0}^{-}} {y}_{lead} ( x ) ⅆ x = {\sum }_{k = 1}^{∞} {y}_{lead} ( k )$$

where:

A₁ is a fraction of the distribution of MPS variance greater than the product order completion time tolerance,

y_{lead} is a magnitude of MPS variance for the planned operations having an product order completion time less than the product order completion time tolerance, and

x is a MPS variance.

k is counter of the discrete iterations of the MPS variance.

The fraction of a distribution of MPS variance less than an product order completion time variance is determined by the formula:

$${A}_{2} = {\int }_{{0}^{+}}^{+ ∞} {y}_{lag} ( x ) ⅆ x = {\sum }_{k = 1}^{∞} {y}_{lag} ( k )$$

where:

A₂ is a fraction of the distribution of MPS variance less than the product order completion time tolerance.

y_{lag} is a magnitude of MPS variance for the planned operations having an product order completion time greater than the product order completion time tolerance.

x is a MPS variance.

k is the counter of the MPS variance.

The fraction of a distribution of MPS variance greater than an product order completion time variance is determined by the formula:

$${A}_{3} = {\int }_{{0}^{-}}^{0 +} y ( x ) ⅆ x = y ( x ) δ ( 0 ) = y ( 0 ) = 1 - {A}_{1} - {A}_{2}$$

where:

A₃ is a fraction of the distribution of MPS variance within the product order completion time tolerance.

y is a magnitude of MPS variance for the planned operations having an product order completion time within the product order completion time tolerance.

x is a MPS variance.

The mean of the distribution of the MPS variance greater than the product order completion time tolerance is determined by the formula:

$$\overline{{X}_{1}} = \frac{{\int }_{- ∞}^{{0}^{-}} y ( x ) x ⅆ x}{{\int }_{- ∞}^{{0}^{-}} y ( x ) ⅆ x} = \frac{1}{{A}_{1}} {\int }_{- ∞}^{{0}^{-}} y ( x ) x ⅆ x = \frac{{\sum }_{k = 1}^{∞} k \cdot {y}_{lead} ( k )}{{\sum }_{k = 1}^{∞} {y}_{lead} ( k )}$$

\overline{X₁} is the mean of the distribution of the MPS variance greater than the product order completion time tolerance.

y is a magnitude of MPS variance for the planned operations having an product order completion time within the product order completion time tolerance, and

x is a MPS variance.

The mean of the distribution of the MPS variance greater than the product order completion time tolerance is determined by the formula:

$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x} = \frac{1}{{A}_{2}} {\int }_{0}^{+ ∞} y ( x ) x ⅆ x = \frac{{\sum }_{k = 1}^{∞} k \cdot {y}_{lag} ( k )}{{\sum }_{k = 1}^{∞} {y}_{la} ( k )}$$

\overline{X₂} is the mean of the distribution of MPS variance less than the product order completion time tolerance.

y is a magnitude of MPS variance for the planned operations having an product order completion time within the product order completion time tolerance, and

x is a MPS variance.

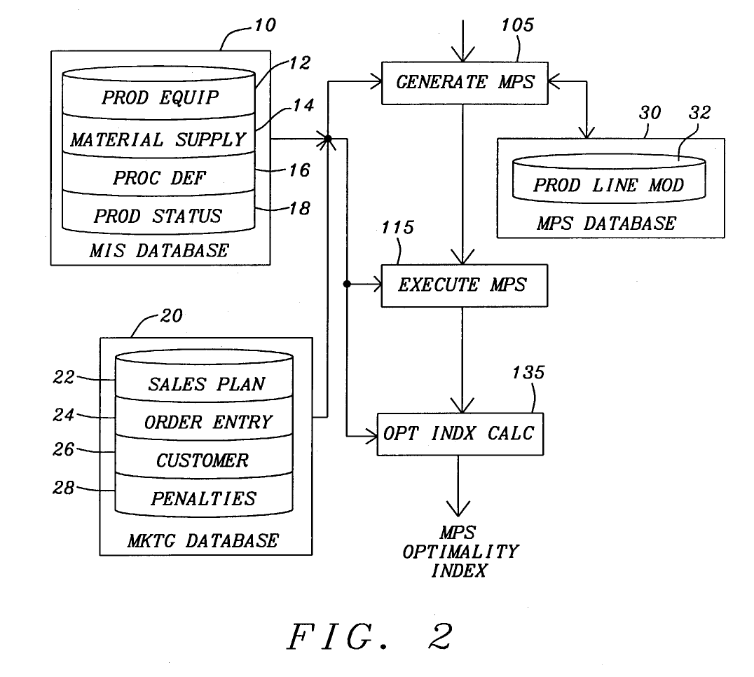

The function of the MPS generator 5 and the optimality index calculator 35 of FIG. 1 may be executed as program code executed within a computing system. Further, the MPS schedule is used to determine the dispatch and scheduling of the product to be fabricated. Refer to FIG. 2 for a discussion of the process or method of the programs as executed. The program obtains the necessary information as described above from the MIS database 10, the marketing database 20, and the MPS database 30 to generate the MPS (Box 105). The MPS is used to provide the necessary information for dispatching and scheduling the processing equipment on the fabrication lines to manufacture (Box 115) the product. The MIS database 10 and the marketing data base 20 provide information on committed orders, available equipment, and raw material supplies for the execution of the MPS (Box 115).

The generated MPS (Box 105), the order completion dates of product fabricated during the execution (Box 115) of the MPS and retained in the production status 18, and the forecast product order completion dates of the sales plan 22 are the input information for the calculation (Box 135) of the MPS optimality index. The calculation (Box 135) provides the MPS optimality index 40 that is used to judge the ability of the MPS generation program in its ability to create an optimum MPS.

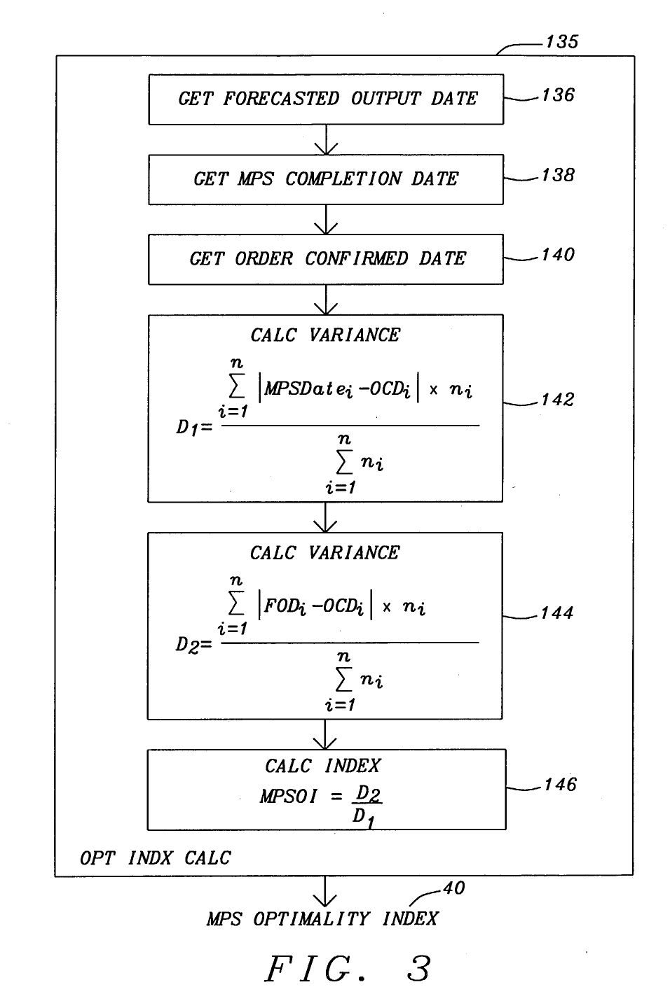

A first embodiment of the method for calculating the optimality index (Box 135) is illustrated in FIG. 3. The forecasted order completion date is retrieved (Box 136) from the sales plan 22 of the marketing database 20. The MPS is acquired (Box 138) as an output of the execution (Box 105) of the MPS generation program. The product order completion dates retrieved from the production status 18 of the MIS database 10. The optimality index calculation (Box 135) performs an MPS variance calculation (Box 142). The MPS variance calculation (Box 142) computes the MPS variance by solving the formula:

$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$

where:

D₁ is the MPS variance.

MPSDateᵢ is the MPS as generated by the MPS generator 5 for operation i.

OCDᵢ is the product order completion date for the operation i.

n is a quantity of each order i with n order counts.

The optimality index calculation (Box 135) performs a forecasted product output date variance calculation (Box 144). The forecasted product output date variance calculation (Box 145) computes the MPS variance by solving the formula:

$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$

where:

D₂ is the forecasted product output date variance.

FODᵢ is the forecasted product output date for operation i.

OCDᵢ is the product order completion date for the operation i.

n is a quantity of each order i with n order counts.

The MPS variance is influenced by the capacity of the fabrication line from changes and allocation in the fabrication equipment. The MPS variance is further influenced by the confirmed order patterns for the quantities and types of products orders. Further the effectiveness of the optimization engine of the program that creates MPS and the reasonability of the settings and rules of the program that creates MPS for the production line model 32 influence the MPS variance. The forecasted product output date variance is influenced by the changes in the capacity of the fabrication line and the confirmed order patterns. The ratio of the MPS variance to the forecasted product output date variance provides an objective criterion for judging the effectiveness of the program that creates MPS.

The optimality index calculation 135 performs an index calculation (Box 146) from the results of the MPS variance calculation (Box 142) and the forecasted product output date variance calculation (Box 144). The index calculation (Box 146) determines the MPS optimality index by solving the formula:

$$MPSOI = \frac{{D}_{2}}{{D}_{1}}$$

where:

MPSOI is the optimality index.

D₁ is the planned operation schedule variance.

D₂ is the forecasted operation schedule variance.

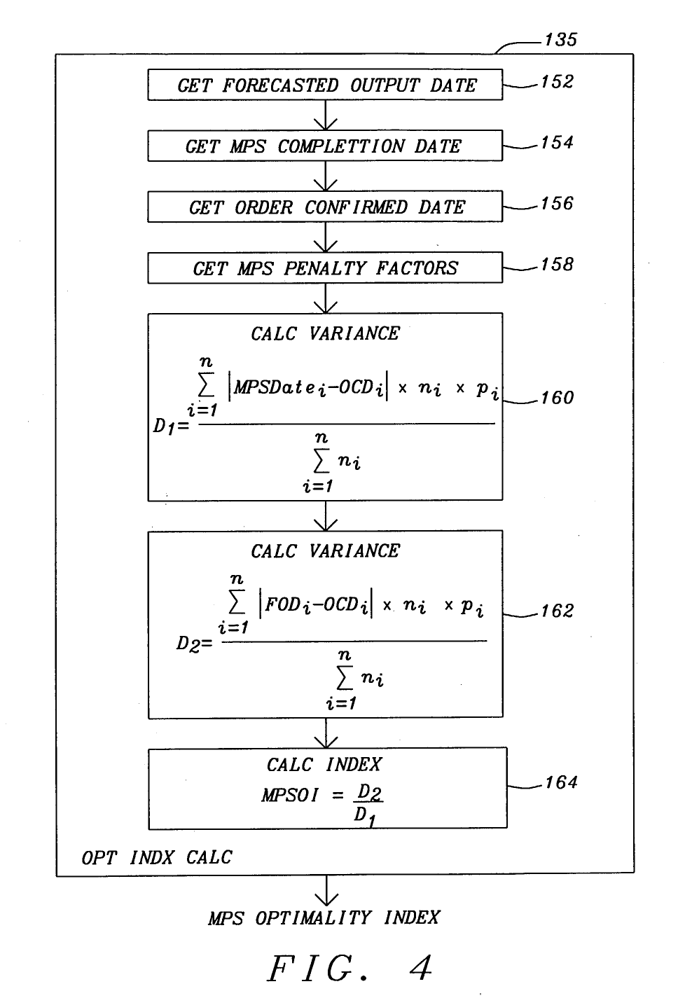

In a second embodiment of the optimality calculation (Box 135), as shown in FIG. 4, a penalty factor is introduced. The penalty factor is a function of the impact of the lead versus the lag of the MPS versus the product order completion dates, the customer tier (the type of customer and penalties caused by variations in product order delivery dates versus the planned delivery date), and business concerns that are affected by the variations in the product order completion dates versus the planned production schedules.

In the second embodiment, the forecasted order completion date is retrieved (Box 152) from the sales plan 22 of the marketing database 20. The MPS is acquired (Box 154) as an output of the execution (Box 105) of the MPS generation program. The product order completion dates retrieved (Box 156) from the production status 18 of the MIS database 10. The optimality index calculation (Box 135) performs an MPS variance calculation (Box 160). The MPS variance calculation (Box 160) computes the MPS variance by solving the formula:

$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$

where:

D₁ is the planned operation schedule variance.

MPSDateᵢ is the MPS as generated by the MPS generator 5 for operation i.

OCDᵢ is the product order completion date for the operation i.

pᵢ is the penalty factor for operation i having missed the operation completion date.

n is a quantity of each operation i with n operation counts.

The optimality index calculation (Box 135) performs a forecasted product output date variance calculation (Box 162). The forecasted product output date variance calculation (Box 145) computes the MPS variance by solving the formula:

$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$

where:

D₂ is the forecasted operation schedule variance.

FODᵢ is the forecasted product output date for operation i.

OCDᵢ is the product order completion date for the operation i.

pᵢ is the penalty factor for operation i having missed the operation completion date.

n is a quantity of each operation i with n operation counts.

The penalties of differentiating between actual product order completion date and the forecasted product output date are difficult to predict and is assumed to be one. Further, the distribution of forecasted product output dates are also, difficult to predict. It can be shown that the MPS is more optimum is if the distribution of the MPS iterations over time are more concentrated, as described above for FIGS. 5a-5l.

In a third embodiment, the calculation (Box 135) of the optimality index determines the concentration and dispersion of the distribution of the variance of multiple MPS iterations, an area for each region of the distribution is calculated. The distribution, as described above in FIG. 6, is divided into three areas, A1, A2, and A3. The optimality index is structured to provide a penalty for more dispersed MPS variation distributions. The areas are determined and combined to form a concentration/dispersion factor used as the optimality index.

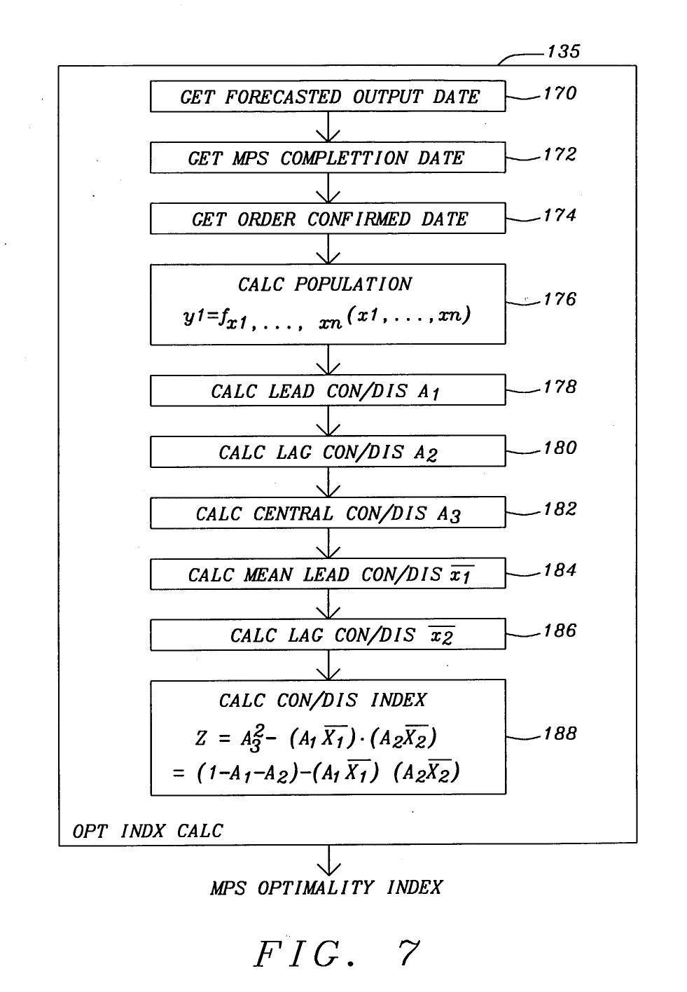

The third embodiment of the determination of the concentration/dispersion factor of the MPS variance is shown in FIG. 7. The forecasted order completion date is retrieved (Box 170) from the sales plan 22 of the marketing database 20. The MPS is acquired (Box 172) as an output of the execution (Box 105) of the MPS generation program. The product order completion dates is retrieved (Box 174) from the production status 18 of the MIS database 10. The population of the multiple iterations of the MPS variance is calculated (Box 176) to determine the distribution of the MPS variances.

The fraction of a distribution of MPS variance greater than an product order completion time variance is determined (Box 178) by the formula:

$${A}_{1} = {\int }_{- ∞}^{{0}^{-}} {y}_{lead} ( x ) ⅆ x = {\sum }_{k = 1}^{∞} {y}_{lead} ( k )$$

where:

A₁ is a fraction of the distribution of MPS variance greater than the product order completion time tolerance,

y_{lead} is a magnitude of MPS variance for the planned operations having an product order completion time less than the product order completion time tolerance, and

x is a MPS variance.

k is counter of the discrete iterations of the MPS variance.

The fraction of a distribution of MPS variance less than an product order completion time variance is determined (Box 180) by the formula:

$${A}_{2} = {\int }_{{0}^{+}}^{+ ∞} {y}_{lag} ( x ) ⅆ x = {\sum }_{k = 1}^{∞} {y}_{lag} ( k )$$

where:

A₂ is a fraction of the distribution of MPS variance less than the product order completion time tolerance.

y_{lag} is a magnitude of MPS variance for the planned operations having an product order completion time greater than the product order completion time tolerance.

x is a MPS variance.

k is the counter of the MPS variance.

The fraction of a distribution of MPS variance greater than an product order completion time variance is determined (Box 182) by the formula:

$${A}_{3} = {\int }_{{0}^{-}}^{0 +} y ( x ) ⅆ x = y ( x ) δ ( 0 ) = y ( 0 ) = 1 - {A}_{1} - {A}_{2}$$

where:

A₃ is a fraction of the distribution of MPS variance within the product order completion time tolerance.

y is a magnitude of MPS variance for the planned operations having an product order completion time within the product order completion time tolerance.

x is a MPS variance.

The mean of the distribution of the MPS variance greater than the product order completion time tolerance is determined (Box 184) by the formula:

$$\overline{{X}_{1}} = \frac{{\int }_{- ∞}^{{0}^{-}} y ( x ) x ⅆ x}{{\int }_{- ∞}^{{0}^{-}} y ( x ) ⅆ x} = \frac{1}{{A}_{1}} {\int }_{- ∞}^{{0}^{-}} y ( x ) x ⅆ x = \frac{{\sum }_{k = 1}^{∞} k \cdot {y}_{lead} ( k )}{{\sum }_{k = 1}^{∞} {y}_{lead} ( k )}$$

\overline{X₁} is the mean of the distribution of the MPS variance greater than the product order completion time tolerance.

y is a magnitude of MPS variance for the planned operations having an product order completion time within the product order completion time tolerance, and

x is a MPS variance.

The mean of the distribution of the MPS variance greater than the product order completion time tolerance is determined (Box 186) by the formula:

$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x} = \frac{1}{{A}_{2}} {\int }_{0}^{+ ∞} y ( x ) x ⅆ x = \frac{{\sum }_{k = 1}^{∞} k \cdot {y}_{lag} ( k )}{{\sum }_{k = 1}^{∞} {y}_{la} ( k )}$$

\overline{X₂} is the mean of the distribution of MPS variance less than the product order completion time tolerance.

y is a magnitude of MPS variance for the planned operations having an product order completion time within the product order completion time tolerance, and

x is a MPS variance.

\overline{X₂} is the mean of the distribution of MPS variance less than the product order completion time tolerance.

\overline{X₂} is the mean of the distribution of MPS variance less than the product order completion time tolerance.

The concentration/dispersion factor is then determined (Box 199) by the formula:

$$\begin{matrix}Z = {A}_{3}^{2} - ( {A}_{1} \overline{{X}_{1}} ) \cdot ( {A}_{2} \overline{{X}_{2}} ) \\ = {( 1 - {A}_{1} - {A}_{2} )}^{2} - ( {A}_{1} \overline{{X}_{1}} ) \cdot ( {A}_{2} \overline{{X}_{2}} )\end{matrix}$$

where:

Z is the concentration/dispersion factor.

A₁ is a fraction of a distribution of the MPS variance greater than an product order completion time tolerance, the product order completion time tolerance being a tolerance of the product order completion times for multiple operations.

A₂ is a fraction of the distribution of MPS variance less than the product order completion time tolerance.

A₃ is a fraction of the distribution of MPS variance within the product order completion time tolerance.

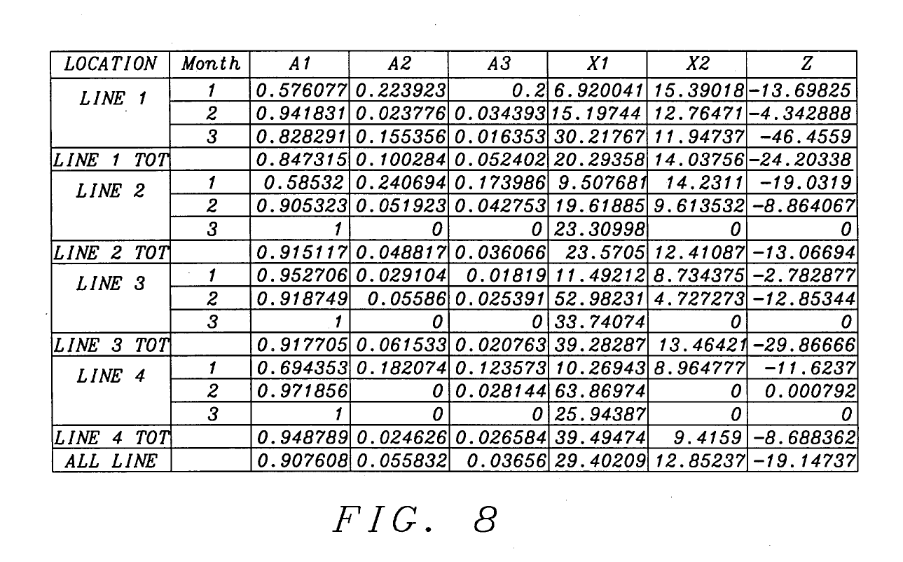

FIG. 8 illustrates a case study comparing the actual product completion times of a group of fabrication lines for three months versus the MPS's as generated during those months. It can be seen that for those months (i.e. Line 1, Month 2; Line 2, Month 3; Line 3, Months 1 and 3; and Line 4, Months 2 and 3) where the distribution for the MPS is more concentrated, the concentration/dispersion factor (Z) approaches a zero. Even though the MPS and the product order completion dates differ, the concentration/dispersion factor (Z) indicates predictability of the MPS generator. Alternately, larger distributions for all the area (A1, A2, and A3) causes the concentration/dispersion factor (Z) to increasingly have a large negative magnitude (i.e. Line 1, Months 1 and 4: Line 2, Months 1 and 2; and Line 3, Months 2; and Line 4, Month 1). Since there are no unique the MPS generation programs for each month, the final optimal solution MPS is generated by a heuristic method, which cannot guarantee that the optimal solution can be found. Therefore, the variation of each month will be varied according to the initial values pre-maintained parameters and the robustness of the heuristics.

The program code as discussed in FIGS. 2-4 and 7 is retained in media such as storage nodes of the cluster network of computer systems or a global communication network such as the Internet, or stored on storage media such as a read only memory (ROM), an electro-optical disk or a magnetic disk.

While this invention has been particularly shown and described with reference to the preferred embodiments thereof, it will be understood by those skilled in the art that various changes in form and details may be made without departing from the spirit and scope of the invention.

The invention claimed is:

1. A method for determining optimality of a planned operation schedule comprising the steps of:
obtaining said planned operation schedule;
obtaining an operation completion time;
determining a planned operation schedule variance from said planned operation schedule and said operation completion time; and
determining an optimality index as a function of said operation schedule variance.

2. The method of claim 1 further comprising the steps of:
obtaining a forecasted operation schedule;
determining a forecasted operation schedule variance from said forecasted operation schedule and said operation completion time; and
determining said optimality index as a function of said forecasted schedule variance.

3. The method of claim 1 wherein said planned operation schedule is a master production schedule as calculated by a program executed on a computer system.

4. The method of claim 1 wherein the forecasted operation schedule is a forecasted order date, which is a predicted date at which a customer is expected to require a product.

5. The method of claim 1 wherein the operation completion date is an order confirmed date indicating completion of fabrication of the product.

6. The method of claim 1 wherein the planned operation schedule variance is determined by a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

7. The method of claim 2 wherein the planned operation schedule variance is determined by a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

8. The method of claim 2 wherein the forecasted operation schedule variance is determined by a formula:
$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
n is a quantity of each operation i with n operation counts.

9. The method of claim 2 wherein the optimality index is determined by a formula:
$$MPSOI = \frac{{D}_{2}}{{D}_{1}}$$
where:
MPSOI is the optimality index,
D₁ is the planned operation schedule variance, and
D₂ is the forecasted operation schedule variance.

10. The method of claim 1 further comprising the step of:
obtaining a penalty factor, said penalty factor incurred for not meeting said planned operation schedule.

11. The method of claim 10 wherein the planned operation schedule variance is determined by a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i;
pᵢ is the penalty factor for operation i having missed the operation completion date.
n is a quantity of each operation i with n operation counts.

12. The method of claim 2 further comprising the step of:
obtaining a penalty factor, said penalty factor incurred for not meeting said planned operation schedule.

13. The method of claim 12 wherein the planned operation schedule variance is determined by a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

14. The method of claim 12 wherein the forecasted operation schedule variance is determined by a formula:
$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
pᵢ is the penalty factor for operation i having missed the operation completion date.
n is a quantity of each operation i with n operation counts.

15. The method of claim 1 wherein the optimality index is a concentration/dispersion factor of the operation schedule variance.

16. The method of claim 15 wherein the concentration/dispersion factor is determined by a formula:
Z=A₃²−(A₁\overline{X₁})·(A₂\overline{X₂})
where:
Z is the concentration/dispersion factor,
A₁ is a fraction of a distribution of the planned operation schedule variance greater than an operation completion time tolerance, said operation completion time tolerance being a tolerance of said operation completion times for multiple operations,
A₂ is a fraction of the distribution of planned operation schedule variance less than the operation completion time tolerance,
A₃ is a fraction of the distribution of planned operation schedule variance within the operation completion time tolerance,
\overline{X₁} is the mean of the distribution of the planned operation schedule variance greater than the operation completion time tolerance, and
\overline{X₂} is the mean of the distribution of planned operation schedule variance less than the operation completion time tolerance.

17. The method of claim 16 wherein the fraction of a distribution of planned operation schedule variance greater than an operation completion time variance is determined by a formula:
$${A}_{1} = {\int }_{- ∞}^{{0}^{-}} {y}_{lead} ( x ) ⅆ x$$
where:
y_{lead} is a magnitude of planned operation schedule variance for the planned operations having an operation completion time less than the operation completion time tolerance, and
x is a planned operation schedule variance.

18. The method of claim 16 wherein the fraction of a distribution of planned operation schedule variance less than an operation completion time variance is determined by a formula:
$${A}_{2} = {\int }_{{0}^{+}}^{+ ∞} {y}_{lag} ( x ) ⅆ x$$
where:
y_{lag} is a magnitude of planned operation schedule variance for the planned operations having an operation completion time greater than the operation completion time tolerance, and
x is a planned operation schedule variance.

19. The method of claim 16 wherein the fraction of a distribution of planned operation schedule variance greater than an operation completion time variance is determined by a formula:
$$\begin{matrix}{A}_{3} = {\int }_{{0}^{-}}^{0 +} y ( x ) ⅆ x \\ = 1 - {A}_{1} - {A}_{2}\end{matrix}$$
where:
y is a magnitude of planned operation schedule variance for the planned operations having an operation completion time within the operation completion time tolerance, and
x is a planned operation schedule variance.

20. The method of claim 16 wherein the mean of the distribution of the planned operation schedule variance greater than the operation completion time tolerance is determined by a formula:
$$\overline{{X}_{1}} = \frac{{\int }_{- ∞}^{0 -} y ( x ) x ⅆ x}{{\int }_{- ∞}^{0 -} y ( x ) ⅆ x}$$
y is a magnitude of planned operation schedule variance for the planned operations having an operation completion time within the operation completion time tolerance, and
x is a planned operation schedule variance.

21. The method of claim 16 wherein the mean of the distribution of the planned operation schedule variance greater than the operation completion time tolerance is determined by a formula:
$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x}$$
y is a magnitude of planned operation schedule variance for the planned operations having an operation completion time within the operation completion time tolerance, and
x is a planned operation schedule variance.

22. An apparatus for determining optimality of a planned operation schedule comprising:
means for obtaining said planned operation schedule;
means for obtaining an operation completion time;
means for determining a planned operation schedule variance from said planned operation schedule and said operation completion time; and
means for determining an optimality index as a function of said operation schedule variance.

23. The apparatus of claim 22 further comprising:
means for obtaining a forecasted operation schedule;
means for determining a forecasted operation schedule variance from said forecasted operation schedule and said operation completion time; and
means for determining said optimality index as a function of said forecasted schedule variance.

24. The apparatus of claim 22 wherein said planned operation schedule is a master production schedule as calculated by a program executed on a computer system.

25. The apparatus of claim 23 wherein the forecasted operation schedule is a forecasted order date, which is a predicted date at which a customer is expected to require a product.

26. The apparatus of claim 22 wherein the operation completion date is an order confirmed date indicating completion of fabrication of the product.

27. The apparatus of claim 22 wherein the means for determining the planned operation schedule variance provides a solution for a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

28. The apparatus of claim 23 wherein the means for determining the planned operation schedule variance provides a solution for a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

29. The apparatus of claim 23 wherein means for determining the forecasted operation schedule variance provides a solution for a formula:
$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
n is a quantity of each operation i with n operation counts.

30. The apparatus of claim 23 wherein the means for determining the optimality index provides a solution for a formula:
$$MPSOI = \frac{{D}_{2}}{{D}_{1}}$$
where:
MPSOI is the optimality index,
D₁ is the planned operation schedule variance, and
D₂ is the forecasted operation schedule variance.

31. The apparatus of claim 22 further comprising:
means for obtaining a penalty factor, said penalty factor incurred for not meeting said planned operation schedule.

32. The apparatus of claim 31 wherein the means for determining the planned operation schedule variance provides a solution for a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

33. The apparatus of claim 23 further comprising:
means for obtaining a penalty factor, said penalty factor incurred for not meeting said planned operation schedule.

34. The apparatus of claim 33 the means for determining the planned operation schedule variance provides a solution for a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

35. The apparatus of claim 33 wherein means for determining the forecasted operation schedule variance provides a solution for a formula:
$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
pᵢ is the penalty factor for operation i having missed the operation completion date.
n is a quantity of each operation i with n operation counts.

36. The apparatus of claim 22 wherein the optimality index is a concentration/dispersion factor of the operation schedule variance.

37. The apparatus of claim 36 wherein the means for determining the optimality index provides a solution for a formula:
Z=A₃²−(A₁\overline{X₁})·(A₂\overline{X₂})
where:
Z is the concentration/dispersion factor,
A₁ is a fraction of a distribution of the planned operation schedule variance greater than an operation completion time tolerance, said operation completion time tolerance being a tolerance of said operation completion times for multiple operations,
A₂ is a fraction of the distribution of planned operation schedule variance less than the operation completion time tolerance,
A₃ is a fraction of the distribution of planned operation schedule variance within the operation completion time tolerance,
\overline{X₁} is the mean of the distribution of the planned operation schedule variance greater than the operation completion time tolerance, and
\overline{X₂} is the mean of the distribution of planned operation schedule variance less than the operation completion time tolerance.

38. The apparatus of claim 37 the means for determining the optimality index generates the fraction of a distribution of planned operation schedule variance greater than an operation completion time variance by providing a solution for a formula:
$${A}_{1} = {\int }_{- ∞}^{{0}^{-}} {y}_{lead} ( x ) ⅆ x$$
where:
y_{lead} is a magnitude of planned operation schedule variance for the planned operations having an operation completion time less than the operation completion time tolerance, and
x is a planned operation schedule variance.

39. The apparatus of claim 37 wherein the means for determining the optimality index generates the fraction of a distribution of planned operation schedule variance less than an operation completion time variance by providing a solution for a formula:
$${A}_{2} = {\int }_{{0}^{+}}^{+ ∞} {y}_{lag} ( x ) ⅆ x$$
where:
y_{lag} is a magnitude of planned operation schedule variance for the planned operations having an operation completion time greater than the operation completion time tolerance, and
x is a planned operation schedule variance.

40. The apparatus of claim 37 wherein the means for determining the optimality index generates the fraction of a distribution of planned operation schedule variance greater than an operation completion time variance by providing a solution for a formula:
$$\begin{matrix}{A}_{3} = {\int }_{{0}^{-}}^{0 +} y ( x ) ⅆ x \\ = 1 - {A}_{1} - {A}_{2}\end{matrix}$$
where:
y is a magnitude of planned operation schedule variance for the planned operations having an operation completion time within the operation completion time tolerance, and
x is a planned operation schedule variance.

41. The apparatus of claim 37 wherein the means for determining the optimality index generates the mean of the distribution of the planned operation schedule variance greater than the operation completion time tolerance by providing a solution for a formula:
$$\overline{{X}_{1}} = \frac{{\int }_{- ∞}^{{0}^{-}} y ( x ) x ⅆ x}{{\int }_{- ∞}^{{0}^{-}} y ( x ) ⅆ x}$$
y is a magnitude of planned operation schedule variance for the planned operations having an operation completion time within the operation completion time tolerance, and
x is a planned operation schedule variance.

42. The apparatus of claim 37 wherein the means for determining the optimality index the mean of the distribution of the planned operation schedule variance greater than the operation completion time tolerance by providing a solution for a formula:
$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x}$$
y is a magnitude of planned operation schedule variance for the planned operations having an operation completion time within the operation completion time tolerance, and
x is a planned operation schedule variance.

43. A calculating device for determining optimality of a planned operation schedule comprising:
a connection to a planned operation scheduling generator for obtaining said planned operation schedule;
a connection to a manufacturing information database for obtaining an operation completion time; and
a first variance calculator for determining a planned operation schedule variance from said planned operation schedule and said operation completion time.

44. The device of claim 43 further comprising:
a connection to a marketing database for obtaining a forecasted operation schedule;
a second variance calculator determining a forecasted operation schedule variance from said forecasted operation schedule and said operation completion time; and
a third variance calculator connected to the first and second variance calculators determining an optimality index as a function of said operation schedule variance to said forecasted schedule variance.

45. The calculating device of claim 43 wherein said planned operation schedule is a master production schedule as calculated by a program executed on a computer system.

46. The calculating device of claim 44 wherein the forecasted operation schedule is a forecasted order date a predicted date at which a customer is expected to require a product.

47. The calculating device of claim 43 wherein the operation completion date is an order confirmed date indicating completion of fabrication of the product.

48. The calculating device of claim 43 wherein the first variance calculator determines the planned operation schedule variance by providing a solution for a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

49. The calculating device of claim 44 wherein the first variance calculator determines the planned operation schedule variance by providing a solution for a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

50. The calculating device of claim 44 wherein the second variance calculator determines the forecasted operation schedule variance by providing a solution for a formula:
$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
n is a quantity of each operation i with n operation counts.

51. The calculating device of claim 44 wherein the third variance calculator determines the optimality index by providing a solution for a formula:
$$MPSOI = \frac{{D}_{2}}{{D}_{1}}$$
where:
MPSOI is the optimality index,
D₁ is the planned operation schedule variance, and
D₂ is the forecasted operation schedule variance.

52. The calculating device of claim 43 wherein the first variance calculator determines the planned operation schedule variance by providing a solution for a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

53. The calculating device of claim 44 wherein the first variance calculator determines the planned operation schedule variance by providing a solution for a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

54. The calculating device of claim 44 wherein the second variance calculator determines the forecasted operation schedule variance by providing a solution for a formula:
$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
pᵢ is the penalty factor for operation i having missed the operation completion date.
n is a quantity of each operation i with n operation counts.

55. The calculating device of claim 43 wherein the optimality index is a concentration/dispersion factor of the operation schedule variance.

56. The calculating device of claim 55 wherein the third variance calculator determines the concentration/dispersion factor by providing a solution for a formula:
Z=A₃²−(A₁\overline{X₁})·(A₂\overline{X₂})
where:
Z is the concentration/dispersion factor,
A₁ is a fraction of a distribution of the planned operation schedule variance greater than an operation completion time tolerance, said operation completion time tolerance being a tolerance of said operation completion times for multiple operations,
A₂ is a fraction of the distribution of planned operation schedule variance less than the operation completion time tolerance,
A₃ is a fraction of the distribution of planned operation schedule variance within the operation completion time tolerance,
\overline{X₁} is the mean of the distribution of the planned operation schedule variance greater than the operation completion time tolerance, and
\overline{X₂} is the mean of the distribution of planned operation schedule variance less than the operation completion time tolerance.

57. The calculating device of claim 56 wherein the fraction of a distribution of planned operation schedule variance greater than an operation completion time variance is determined by a formula:
$${A}_{1} = {\int }_{- ∞}^{{0}^{-}} {y}_{lead} ( x ) ⅆ x$$
where:
y_{lead} is a magnitude of planned operation schedule variance for the planned operations having an operation completion time less than the operation completion time tolerance, and
x is a planned operation schedule variance.

58. The calculating device of claim 56 wherein the fraction of a distribution of planned operation schedule variance less than an operation completion time variance is determined by a formula:
$${A}_{2} = {\int }_{{0}^{+}}^{+ ∞} {y}_{lag} ( x ) ⅆ x$$
where:
y_{lag} is a magnitude of planned operation schedule variance for the planned operations having an operation completion time greater than the operation completion time tolerance, and
x is a planned operation schedule variance.

59. The calculating device of claim 56 wherein the fraction of a distribution of planned operation schedule variance greater than an operation completion time variance is determined by a formula:
$$\begin{matrix}{A}_{3} = {\int }_{{0}^{-}}^{0 +} y ( x ) ⅆ x \\ = 1 - {A}_{1} - {A}_{2}\end{matrix}$$
where:
y is a magnitude of planned operation schedule variance for the planned operations having an operation completion time within the operation completion time tolerance, and
x is a planned operation schedule variance.

60. The calculating device of claim 56 wherein the mean of the distribution of the planned operation schedule variance greater than the operation completion time tolerance is determined by a formula:
$$\overline{{X}_{1}} = \frac{{\int }_{- ∞}^{{0}^{-}} y ( x ) x ⅆ x}{{\int }_{- ∞}^{{0}^{-}} y ( x ) ⅆ x}$$
y is a magnitude of planned operation schedule variance for the planned operations having an operation completion time within the operation completion time tolerance, and
x is a planned operation schedule variance.

61. The calculating device of claim 56 wherein the mean of the distribution of the planned operation schedule variance greater than the operation completion time tolerance is determined by a formula:
$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x}$$
y is a magnitude of planned operation schedule variance for the planned operations having an operation completion time within the operation completion time tolerance, and
x is a planned operation schedule variance.

62. A computing system in communication with a marketing database, a manufacturing information database and a planned operation scheduling generator, said computing system executing a wherein the program process for determining optimality of a planned operation schedule comprising the steps of:
obtaining said planned operation schedule;
obtaining an operation completion time;
determining a planned operation schedule variance from said planned operation schedule and said operation completion time; and
determining an optimality index as a function of said operation schedule variance.

63. The computing system of claim 62 wherein said wherein the program process further comprises the steps of:
obtaining a forecasted operation schedule;
determining a forecasted operation schedule variance from said forecasted operation schedule and said operation completion time; and
determining said optimality index as a function of said forecasted schedule variance.

64. The computing system of claim 62 wherein said planned operation schedule is a master production schedule as calculated by a program executed on a computer system.

65. The computing system of claim 62 wherein the forecasted operation schedule is a forecasted order date, which is a predicted date at which a customer is expected to require a product.

66. The computing system of claim 62 wherein the operation completion date is an order confirmed date indicating completion of fabrication of the product.

67. The computing system of claim 62 wherein the program process determines the planned operation schedule variance by solving a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

68. The computing system of claim 63 wherein the program process determines the planned operation schedule variance by solving a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

69. The computing system of claim 63 wherein the program process determines the forecasted operation schedule variance by solving a formula:
$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
n is a quantity of each operation i with n operation counts.

70. The computing system of claim 63 wherein the wherein the program process determines the optimality index by solving a formula:
$$MPSOI = \frac{{D}_{2}}{{D}_{1}}$$
where:
MPSOI is the optimality index,
D₁ is the planned operation schedule variance, and
D₂ is the forecasted operation schedule variance.

71. The computing system of claim 62 wherein the wherein the program process further comprises the step of:
obtaining a penalty factor, said penalty factor incurred for not meeting said planned operation schedule.

72. The computing system of claim 71 wherein the program process determines the planned operation schedule variance by solving a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

73. The computing system of claim 63 wherein the wherein the program process further comprises the step of:
obtaining a penalty factor, said penalty factor incurred for not meeting said planned operation schedule.

74. The computing system of claim 73 wherein the wherein the program process determines the planned operation schedule variance by solving a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

75. The computing system of claim 73 wherein the wherein the program process determines the forecasted operation schedule variance by solving a formula:
$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
pᵢ is the penalty factor for operation i having missed the operation completion date.
n is a quantity of each operation i with n operation counts.

76. The computing system of claim 62 wherein the optimality index is a concentration/dispersion factor of the operation schedule variance.

77. The computing system of claim 76 wherein the wherein the program process determines the concentration/dispersion factor by solving a formula:
Z=A₃²−(A₁\overline{X₁})·(A₂\overline{X₂})
where:
Z is the concentration/dispersion factor,
A₁ is a fraction of a distribution of the planned operation schedule variance greater than an operation completion time tolerance, said operation completion time tolerance being a tolerance of said operation completion times for multiple operations,
A₂ is a fraction of the distribution of planned operation schedule variance less than the operation completion time tolerance,
A₃ is a fraction of the distribution of planned operation schedule variance within the operation completion time tolerance,
\overline{X₁} is the mean of the distribution of the planned operation schedule variance greater than the operation completion time tolerance, and
\overline{X₂} is the mean of the distribution of planned operation schedule variance less than the operation completion time tolerance.

78. The computing system of claim 77 wherein the fraction of a distribution of planned operation schedule variance greater than an operation completion time variance is determined by a formula:
$${A}_{1} = {\int }_{- ∞}^{{0}^{-}} {y}_{lead} ( x ) ⅆ x$$
where:
y_{lead} is a magnitude of planned operation schedule variance for the planned operations having an operation completion time less than the operation completion time tolerance, and
x is a planned operation schedule variance.

79. The computing system of claim 77 wherein the fraction of a distribution of planned operation schedule variance less than an operation completion time variance is determined by a formula:
$${A}_{2} = {\int }_{{0}^{+}}^{+ ∞} {y}_{lag} ( x ) ⅆ x$$
where:
y_{lag} is a magnitude of planned operation schedule variance for the planned operations having an operation completion time greater than the operation completion time tolerance, and
x is a planned operation schedule variance.

80. The computing system of claim 77 wherein the fraction of a distribution of planned operation schedule variance greater than an operation completion time variance is determined by a formula:
$$\begin{matrix}{A}_{3} = {\int }_{{0}^{-}}^{0 +} y ( x ) ⅆ x \\ = 1 - {A}_{1} - {A}_{2}\end{matrix}$$
where:
y is a magnitude of planned operation schedule variance for the planned operations having an operation completion time within the operation completion time tolerance, and
x is a planned operation schedule variance.

81. The computing system of claim 77 wherein the mean of the distribution of the planned operation schedule variance greater than the operation completion time tolerance is determined by a formula:
$$\overline{{X}_{1}} = \frac{{\int }_{- ∞}^{{0}^{-}} y ( x ) x ⅆ x}{{\int }_{- ∞}^{{0}^{-}} y ( x ) ⅆ x}$$
y is a magnitude of planned operation schedule variance for the planned operations having an operation completion time within the operation completion time tolerance, and
x is a planned operation schedule variance.

82. The computing system of claim 77 wherein the mean of the distribution of the planned operation schedule variance greater than the operation completion time tolerance is determined by a formula:
$$\overline{{X}_{2}} = \frac{{\int }_{{0}^{+}}^{+ ∞} y ( x ) x ⅆ x}{{\int }_{{0}^{+}}^{+ ∞} y ( x ) ⅆ x}$$
y is a magnitude of planned operation schedule variance for the planned operations having an operation completion time within the operation completion time tolerance, and
x is a planned operation schedule variance.

83. A medium for retaining a computer program which, when implemented by a computing system, executes a process for determining optimality of a planned operation schedule, said process comprising the steps of:
obtaining said planned operation schedule;
obtaining an operation completion time;
determining a planned operation schedule variance from said planned operation schedule and said operation completion time; and
determining an optimality index as a function of said operation schedule variance.

84. The medium of claim 83 wherein said process further comprises the steps of:
obtaining a forecasted operation schedule;
determining a forecasted operation schedule variance from said forecasted operation schedule and said operation completion time; and
determining said optimality index as a function of said forecasted schedule variance.

85. The medium of claim 83 wherein said planned operation schedule is a master production schedule as calculated by a program executed on a computer system.

86. The medium of claim 83 wherein the forecasted operation schedule is a forecasted order date, which is a predicted date at which a customer is expected to require a product.

87. The medium of claim 83 wherein the operation completion date is an order confirmed date indicating completion of fabrication of the product.

88. The medium of claim 83 wherein the process determines the planned operation schedule variance by solving a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

89. The medium of claim 84 wherein the process determines the planned operation schedule variance by solving a formula:
$${D}_{1} = \frac{{\sum }_{i = 1}^{n} \vert {MPSDate}_{i} - {OCD}_{i} \vert \times {n}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
n is a quantity of each operation i with n operation counts.

90. The medium of claim 84 wherein the process determines the forecasted operation schedule variance by solving a formula:
$${D}_{2} = \frac{{\sum }_{i = 1}^{n} \vert {FOD}_{i} - {OCD}_{i} \vert \times {n}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
n is a quantity of each operation i with n operation counts.

91. The medium of claim 84 wherein the process determines the optimality index by solving a formula:
$$MPSOI = \frac{{D}_{2}}{{D}_{1}}$$
where:
MPSOI is the optimality index,
D₁ is the planned operation schedule variance, and
D₂ is the forecasted operation schedule variance.

92. The medium of claim 83 wherein the process further comprises the step of:
obtaining a penalty factor, said penalty factor incurred for not meeting said planned operation schedule.

93. The medium of claim 92 wherein the process determines the planned operation schedule variance by solving a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCD_{I} is the operation completion date for the operation i,
pᵢ is the penalty factor for operation i having missed the operation completion date.
n is a quantity of each operation i with n operation counts.

94. The medium of claim 84 wherein the process further comprises the step of:
obtaining a penalty factor, said penalty factor incurred for not meeting said planned operation schedule.

95. The medium of claim 94 wherein the process determines the planned operation schedule variance by solving a formula:
$${D}_{1} = \frac{{\sum }_{i = 1}^{n} \vert {MPSDate}_{i} - {OCD}_{i} \vert \times {n}_{i} \times {p}_{i}}{{\sum }_{i = 1}^{n} {n}_{i}}$$
where:
D₁ is the planned operation schedule variance,
MPSDateᵢ is the planned operation schedule for operation i,
OCDᵢ is the operation completion date for the operation i,
pᵢ is the penalty factor for operation i having missed the operation completion date.
n is a quantity of each operation i with n operation counts.

96. The medium of claim 94 wherein the process determines the forecasted operation schedule variance by solving a formula:
$${D}_{2} = \frac{{\sum }_{i = 1}^{n} \vert {FOD}_{i} - {OCD}_{i} \vert \times {n}_{i} \times {p}_{i}}{{\sum }_{i = 1}^{n} {n}_{i}}$$
where:
D₂ is the forecasted operation schedule variance,
FODᵢ is the forecasted operation schedule for operation i,
OCDᵢ is the operation completion date for the operation i, and
pᵢ is the penalty factor for operation i having missed the operation completion date.
n is a quantity of each operation i with n operation counts.

97. The medium of claim 83 wherein the optimality index is a concentration/dispersion factor of the operation schedule variance.

98. The medium of claim 97 wherein the process determines the concentration/dispersion factor by solving a formula:
Z=A₃²−(A₁\overline{X₁})·(A₂\overline{X₂})
where:
Z is the concentration/dispersion factor,
A₁ is a fraction of a distribution of the planned operation schedule variance greater than an operation completion time tolerance, said operation completion time tolerance being a tolerance of said operation completion times for multiple operations,
A₂ is a fraction of the distribution of planned operation schedule variance less than the operation completion time tolerance,
A₃ is a fraction of the distribution of planned operation schedule variance within the operation completion time tolerance,
\overline{X₁} is the mean of the distribution of the planned operation schedule variance greater than the operation completion time tolerance, and
\overline{X₂} is the mean of the distribution of planned operation schedule variance less than the operation completion time tolerance.

99. The medium of claim 98 wherein the fraction of a distribution of planned operation schedule variance greater than an operation completion time variance is determined by a formula:
$${A}_{1} = {\int }_{- ∞}^{{0}^{-}} {y}_{lead} ( x ) ⅆ x$$
where:
y_{lead} is a magnitude of planned operation schedule variance for the planned operations having an operation completion time less than the operation completion time tolerance, and
x is a planned operation schedule variance.

100. The medium of claim 98 wherein the fraction of a distribution of planned operation schedule variance less than an operation completion time variance is determined by a formula:
$${A}_{2} = {\int }_{{0}^{+}}^{+ ∞} {y}_{lag} ( x ) ⅆ x$$
where:
y_{lag} is a magnitude of planned operation schedule variance for the planned operations having an operation completion time greater than the operation completion time tolerance, and
x is a planned operation schedule variance.

101. The medium of claim 98 wherein the fraction of a distribution of planned operation schedule variance greater than an operation completion time variance is determined by a formula:
$${A}_{3} = {\int }_{{0}^{-}}^{0 +} y ( x ) ⅆ x \\ = 1 - {A}_{1} - {A}_{2}$$
where:
y is a magnitude of planned operation schedule variance for the planned operations having an operation completion time within the operation completion time tolerance, and
x is a planned operation schedule variance.

102. The medium of claim 98 wherein the mean of the distribution of the planned operation schedule variance greater than the operation completion time tolerance is determined by a formula:
$$\overline{{x}_{1}} = \frac{{\int }_{- ∞}^{{0}^{-}} y ( x ) x ⅆ x}{{\int }_{- ∞}^{{0}^{-}} y ( x ) ⅆ x}$$
y is a magnitude of planned operation schedule variance for the planned operations having an operation completion time within the operation completion time tolerance, and
x is a planned operation schedule variance.

103. The medium of claim 98 wherein the mean of the distribution of the planned operation schedule variance greater than the operation completion time tolerance is determined by a formula:
$$\overline{{x}_{2}} = \frac{{\int }_{{0}^{+}}^{+ ∞} y ( x ) x ⅆ x}{{\int }_{{0}^{+}}^{+ ∞} y ( x ) ⅆ x }$$
y is a magnitude of planned operation schedule variance for the planned operations having an operation completion time within the operation completion time tolerance, and
x is a planned operation schedule variance.
